(19) United States
(12) Patent Application Publication
(10) Pub. No.: US 2013/0113919 A1
(43) Pub. Date: May 9, 2013

(54) HIGH RESOLUTION AUTOFOCUS INSPECTION SYSTEM

(71) Applicants: Yi Qiao, Woodbury, MN (US); Jack W. Lai, Lake Elmo, MN (US); Jeffrey J. Fontaine, Woodbury, MN (US); Steven C. Reed, Stillwater, MN (US); Catherine P. Tarnowski, Mahtomedi, MN (US); David L. Hofeldt, Oakdale, MN (US)

(72) Inventors: Yi Qiao, Woodbury, MN (US); Jack W. Lai, Lake Elmo, MN (US); Jeffrey J. Fontaine, Woodbury, MN (US); Steven C. Reed, Stillwater, MN (US); Catherine P. Tarnowski, Mahtomedi, MN (US); David L. Hofeldt, Oakdale, MN (US)

(73) Assignee: 3M INNOVATIVE PROPERTIES COMPANY, ST. PAUL, MN (US)

(21) Appl. No.: 13/809,440

(22) PCT Filed: Jul. 13, 2011
(86) PCT No.: PCT/US2011/043851

§ 371 Date: Jan. 10, 2013

Related U.S. Application Data
(60) Provisional application No. 61/364,984, filed on Jul. 16, 2010.

(51) Int. Cl. G01N 21/95; H04N 7/18

(52) U.S. Cl. CPC G01N 21/95; H04N 7/18
USPC 348/92

(57) ABSTRACT

An inspection device comprises a camera assembly including an objective lens that captures and collimates light associated with an object being inspected, an image forming lens that forms an image of the object based on the collimated light, and a camera that renders the image. The camera assembly defines a focal point distance from the objective lens that defines a focal point of the camera assembly. The inspection device comprises an optical sensor positioned to detect an actual distance between the objective lens and the object, an actuator that controls positioning of the objective lens to control the actual distance between the objective lens and the object, and a control unit that receives signals from the optical sensor indicative of the actual distance. Control signals from the control unit can control the actuator to adjust the actual distance such that the actual distance substantially equals the focal point distance.

### CROSS REFERENCE TO RELATED APPLICATION

This application claims the benefit of U.S. Provisional Patent Application No. 61/364,984, filed Jul. 16, 2010, the disclosure of which is incorporated by reference herein in its entirety.

### TECHNICAL FIELD

The invention relates to web manufacturing techniques.

### BACKGROUND

Web manufacturing techniques are used in a wide variety of industries. Web material generally refers to any sheet-like material having a fixed dimension in a cross-web direction, and either a predetermined or indeterminate length in the down-web direction. Examples of web materials include, but are not limited to, metals, paper, woven materials, non-woven materials, glass, polymeric films, flexible circuits, tape, and combinations thereof. Metal materials that are sometimes manufactured in webs include steel and aluminum, although other metals could also be web manufactured. Woven materials generally refer to fabrics. Non-woven materials include paper, filter media, and insulating material, to name a few. Films include, for example, clear and opaque polymeric films including laminates and coated films, as well as a variety of optical films used in computer displays, televisions and the like.

Web manufacturing processes typically utilize continuous feed manufacturing systems, and often include one or more motor-driven or web-driven rotatable mechanical components, such as rollers, casting wheels, pulleys, gears, pull rollers, idler rollers, and the like. These systems often include electronic controllers that output control signals to engage the motors and drive the web at pre-determined speeds.

In many situations, it is desirable to inspect web materials for defects of flaws in the web materials. Web material inspection may be particularly important for any web materials designed with specific characteristics or properties, in order to ensure that defects are not present in such characteristics or properties. Manual inspection, however, may limit the throughput of web manufacturing, and can be prone to human error.

### SUMMARY

This disclosure describes an automated inspection system, device, and techniques for high resolution inspection of features on a web material. The techniques may be especially useful for high-resolution inspection of web materials that are manufactured to include micro-structures on a micron-sized scale. The techniques are useful for inspection of web materials that travel along a web including micro-replicated structures and micro-printed structures such as those created by micro-contact printing. In addition, the techniques may also be used for inspection of individual and discrete objects that travel on a conveyor. The structure and techniques described in this disclosure can facilitate accurate inspection and auto-focus of high-resolution inspection optics, focusing to within tolerances less than 10 microns. The described auto-focus inspection optics may compensate for so-called web flutter in the z-axis, which refers to an axis that is orthogonal to the surface of a two-dimensional web or conveyor. By achieving auto-focus at these tolerances, web inspection can be significantly improved, thereby improving the manufacturing process associated with web materials that have feature sizes less than 5 microns or even less than one micron.

In one example, this disclosure describes an inspection device. The inspection device may comprise a camera assembly including an objective lens that captures and collimates light associated with an object being inspected, an image forming lens that forms an image of the object based on the collimated light, and a camera that renders the image for inspection of the object, wherein the camera assembly defines a focal point distance from the objective lens that defines a focal point of the camera assembly. The inspection device may also comprise an optical sensor positioned to detect an actual distance between the objective lens and the object, an actuator that controls positioning of the objective lens to control the actual distance between the objective lens and the object, wherein the image forming lens remains in a fixed location when the actuator moves the objective lens, and a control unit that receives signals from the optical sensor indicative of the actual distance, and generates control signals for the actuator to adjust the actual distance such that the actual distance remains substantially equal to the focal point distance.

In another example, this disclosure describes a web system that makes use of the inspection device. The web system may comprise a web material defining a down-web dimension and a cross-web dimension, wherein a z-dimension is orthogonal to the down-web dimension and the cross-web dimension, one or more web-guiding elements that feed the web through the web system, and inspection device. The inspection device may include a camera assembly comprising an objective lens that captures and collimates light associated with the web material, an image forming lens that forms an image of the web material based on the collimated light, and a camera that renders the image for inspection of the web material, wherein the camera assembly defines a focal point distance from the objective lens that defines a focal point of the camera assembly. In addition, the inspection device may include an optical sensor positioned to detect an actual distance in the z-dimension between the objective lens and the web material, an actuator that controls positioning of the objective lens relative to the web material to control the actual distance between the objective lens and the web material in the z-dimension, wherein the image forming lens remains in a fixed location when the actuator moves the objective lens, and a control unit that receives signals from the optical sensor indicative of the actual distance in the z-dimension, and generates control signals for the actuator to adjust the actual distance in the z-dimension such that the actual distance in the z-dimension remains substantially equal to the focal point distance.

In another example, this disclosure describes a method. The method may comprise capturing one or more images of an object via a camera assembly positioned relative to the object, wherein the camera assembly comprises an objective lens that captures and collimates light associated with the object, an image forming lens that forms an image of the object based on the collimated light, and a camera that renders the one or more images for inspection of the object, wherein the camera assembly defines a focal point distance from the objective lens that defines a focal point of the camera assembly. The method may also comprise detecting, via an optical sensor, an actual distance between the objective lens and the object, generating, via a control unit, control signals for an actuator that controls positioning of the objective lens, wherein the control unit receives signals from the optical sensor indicative of the actual distance, and generates the control signals based on the received signals from the optical sensor, and applying the control signals for the actuator to adjust positioning of the objective lens relative to the object to control the actual distance between the objective lens and the object such that the actual distance remains substantially equal to the focal point distance, wherein the image forming lens remains in a fixed location when the actuator moves the objective lens.

The details of one or more examples of this disclosure are set forth in the accompanying drawings and the description below. Other features, objects, and advantages associated with the examples will be apparent from the description and drawings, and from the claims.

### BRIEF DESCRIPTION OF DRAWINGS

FIG. 1 is a conceptual diagram illustrating a portion of a web-based manufacturing system that may implement one or more aspects of this disclosure.

FIG. 2 is a block diagram illustrating an inspection device consistent with this disclosure.

FIG. 3 is a conceptual diagram illustrating positioning of an objective lens relative to a web material.

FIG. 4 is a conceptual diagram illustrating an optical sensor that may be configured to detect an actual distance to an object (such as a web material) in real-time.

FIG. 5 is a cross-sectional conceptual diagram illustrating a camera assembly consistent with this disclosure.

FIG. 6 is a flow diagram illustrating a technique consistent with this disclosure.

### DETAILED DESCRIPTION

This disclosure describes an automated inspection system, device, and techniques for high resolution inspection of features on a web material. The techniques may be especially useful for high-resolution inspection of web materials that are manufactured to include micro-structures on a micron-sized scale, including micro-replicated structures and micro-printed structures such as those created by micro-contact printing. In addition, the techniques may also be used for micron-sized inspection of objects on a conveyor. At this micron-sized scale, image-based inspection may require high-resolution optics and high-resolution camera equipment in order to render images that can facilitate such inspection, either for automated inspection or manual inspection of images. However, high resolution camera assemblies typically also define very small focal point tolerances. For example, a camera assembly that defines resolutions less than approximately 1 micron may also define a focal point tolerance less than approximately 2 microns. In this case, an object must be located precisely at a distance corresponding to the focal point of the camera assembly, e.g., within a +/− range of 2 microns of that focal point distance in order to ensure that images rendered by the camera assembly are in focus.

Web manufacturing processes typically utilize continuous feed manufacturing systems, and often include one or more motor-driven or web-driven rotatable mechanical components, such as rollers, casting wheels, pulleys, gears, pull rollers, idler rollers, and the like. Systems that implements web manufacturing may include electronic controllers that output control signals to engage the motors and drive the web at pre-determined speeds and/or with pre-determined force. The web materials may be coated, extruded, stretched, molded, micro-replicated, treated, polished, or otherwise processed on the web. Again, a web material generally refers to any sheet-like material having a fixed dimension in a cross-web direction, and either a predetermined or indeterminate length in the down-web direction, and examples of web materials include, but are not limited to, metals, paper, woven materials, non-woven materials, glass, polymeric films, optical films, flexible circuits, micro-replicated structures, microneedles, micro-contact printed webs, tape, and combinations thereof. Many of these materials require inspection in order to identify defects in the manufacturing process. Automated inspection using a camera-based system and image analysis is highly desirable in such systems, and the techniques of this disclosure may improve automated inspection, particularly at high resolutions.

Automated web-based inspection of web materials may be particularly challenging for high-resolution inspection due to the tight tolerances associated with high-resolution imaging. For example, web flutter can cause the web material to move up and down along a so-called “z axis,” and this web flutter may cause movement on the order of approximately 200 microns. With the generally constant motion of the web, the web flutter can cause high-resolution camera assemblies to become out of focus. This disclosure describes devices, techniques, and systems that can compensate for such web flutter and ensure that a camera assembly remains in focus relative to the web material. In addition, the techniques may also compensate for things such as baggy web, bagginess, buckle, run out, curl, and possibly even tension-induced wrinkles or flatness issues that could be encountered on a web. In general, any “out of plane” defects of the imaged object caused for any reason could benefit from the teaching of this disclosure. The imaging may occur with respect to a web, an object on a conveyor or any other object that may be imaged as it passes the camera assembly.

To achieve such compensation for web flutter or any other web movement or changes of the object or web being imaged, optical detection of z-axis motion of the web material (or other object) may be measured in real time, and such optical detection of the z-axis motion of the web material can be exploited to drive a piezoelectric actuator to adjust positioning of optical components of a camera assembly. In this way, the camera assembly can be adjusted in a constant and continues feed-back loop, such that the distance between an objective lens of the camera assembly and the web material can be maintained at a focal point distance to within a focal point tolerance. Also, to facilitate and/or simplify the adjustment of the distance between the objective lens of the camera assembly and the web material, the piezoelectric actuator may be used to move only the objective lens, and not the other more bulky optical components of the camera assembly. Thus, an image forming lens of the camera assembly (as well as the camera) may remain in a fixed location when the actuator moves the objective lens.

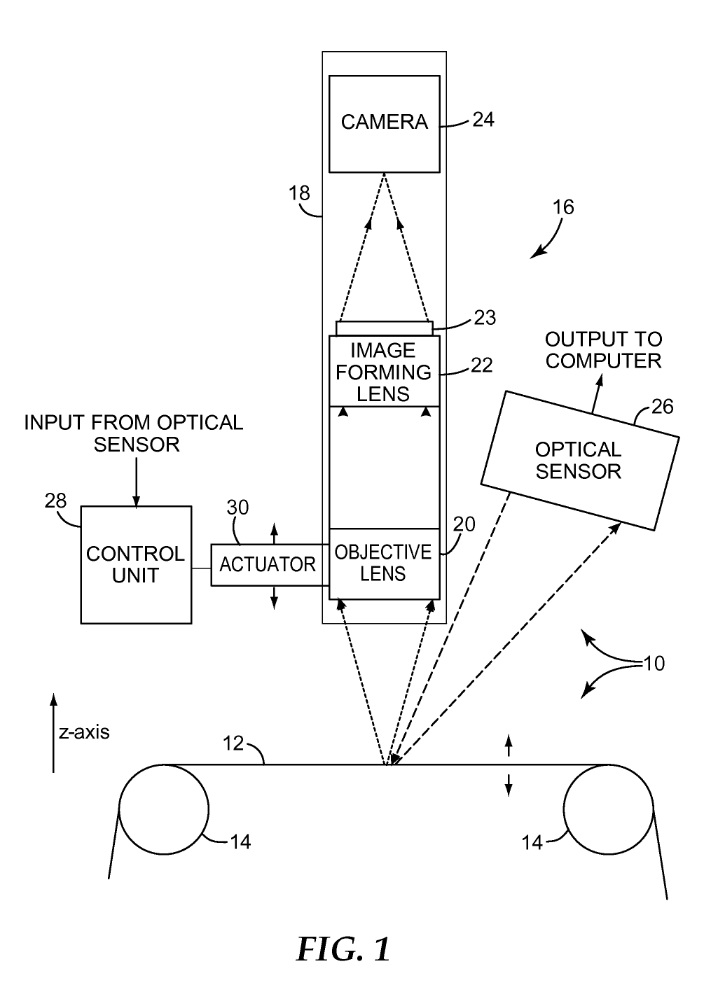

FIG. 1 is a conceptual diagram illustrating a portion of an exemplary web-based manufacturing system 10 that may implement one or more aspects of this disclosure. Although system 10 will be used to describe features of this disclosure, conveyor systems or other systems used to process discrete objects may also benefit from the teachings herein.

System 10 includes a web material 12 which may comprise a long sheet-like form factor that defines a down-web dimension and a cross-web dimension. A z-dimension is labeled as “z-axis” and is orthogonal to the down-web dimension and the cross-web dimension. The techniques of this disclosure may specifically compensate the imaging system to address flutter in the z-dimension along the z-axis shown in FIG. 1.

System 10 may include one or more web-guiding elements 14 that feed web material 12 through the web system. Web-guiding elements 14 may generally represent a wide variety of mechanical components, such as rollers, casting wheels, air bearings, pulleys, gears, pull rollers, extruders, gear pumps, and the like.

In order to inspect web material 12 during the manufacturing process, system 10 may include an inspection device 16 consistent with this disclosure. In particular, inspection device 16 may include a camera assembly 18 comprising an objective lens 20 that captures and collimates light associated with web material 12, an image forming lens 22 that forms an image of web material 12 based on the collimated light, and a camera 24 that renders the image for inspection of web material 12, wherein camera assembly 18 defines a focal point distance from objective lens 20 that defines a focal point of camera assembly 18. The focal point distance of camera assembly 18 may be the same as the focal point distance of objective lens 18 insofar as objective lens 18 may define the focal point for assembly 18 relative to an object being imaged. Camera assembly 18 may also include a wide variety of other optical elements, such as mirrors, waveguides, filters, or the like. A filter 23 may be positioned to filter the output of image forming lens 22 in order to filter out light from optical sensor 26. In this case, the wavelength of light used by optical sensor 26 may correspond to the wavelength of light blocked by filter 23, which can avoid artifacts in the imaging process due to the presence of stray light from optical sensor 26.

In system 10, an optical sensor 26 may be positioned to detect an actual distance in the z-dimension (e.g., along the z-axis labeled in FIG. 1) between objective lens 20 and web material 12. In this way, optical sensor 26 may measure web flutter along the z-dimension. Optical sensor 26 may generate signals indicative of the actual distance to control unit 28, which may, in turn, generate control signals for an actuator 30. Actuator 30 may comprise a piezoelectric crystal actuator that controls positioning of objective lens 20 relative to web material 12 to thereby control the actual distance between objective lens 20 and web material 12 in the z-dimension. In this way, system 10 may define a feedback loop in which the actual distance is measured in real time, and adjusted in real time, such that the actual distance in the z-dimension remains substantially equal to the focal point distance associated with camera assembly 18. However, in other examples, actuator 30 may comprise a voice coil actuator, a linear motor, a magnetostrictive actuator, or another type of actuator.

Objective lens 20 may comprise a single objective lens, or may comprise a first plurality of lenses that collectively define objective lens 20. Similarly, image forming lens 22 may comprises a single lens, or may comprise a second plurality of lenses that collectively define image forming lens 22. In one example, image forming lens 22 may comprise a second plurality of lenses that collectively define a tube lens, as explained in greater detail below.

In accordance with this disclosure, actuator 30 may be coupled to objective lens 20 in order to move objective lens 20 without moving other components of camera assembly 18. This may help to ensure fast response time and may help to simplify system 10. For example, in the case where actuator 30 is a piezoelectric crystal, it may be desirable to limit the load that is movable by actuator 30. The weight of objective lens 20 may be less than one-tenth of a weight of the entire camera assembly 18. For example, the weight of objective lens 20 may be less than one pound (less than 0.455 kilograms) and the weight of camera assembly 18 may be greater than 5 pounds (greater than 2.27 kilograms). In one specific example, the weight of objective lens 20 may be 0.5 pounds (0.227 kilograms) and the weight of camera assembly 18 may be 10 pounds (4.545 kilograms).

Since the light that exits objective lens 20 is collimated light, the distance between objective lens 20 and image forming lens 22 can change without negatively impacting the focus of camera assembly 18. At the same time, however, movements of objective lens 20 can be used to focus camera assembly 18 relative to web material 12 in order to account for slight movement (e.g. flutter) of web material 12. Accordingly, it may be desirable for actuator 30 to move objective lens 20 without moving other components of camera assembly 18. Accordingly, image forming lens 22 and camera 24 remain in fixed locations when actuator 30 moves objective lens 20.

As mentioned, the techniques of this disclosure may be particularly useful for high resolution imaging of web materials. In some cases, web material 12 moves past the inspection device 16 and flutters a flutter distance between 25 microns and 1000 microns. Inspection device 16 may be positioned relative to web material 16, and objective lens 20 can be controlled in real-time to ensure that camera assembly 18 remains substantially in focus on web material 12 due to actuator 30 controlling positioning of objective lens 20 to compensate for the flutter distance, which may change over time. Camera assembly 18 may define a resolution less than approximately 2 microns, and the focal point distance from objective lens 20 associated with the focal point of camera assembly 18 may define a focal point tolerance less than approximately 10 microns. Even at these tight tolerances, actuator 30 (e.g., in the form of a piezoelectric crystal actuator) may adjust the actual distance between objective lens 20 and web material 12 in the z-dimension such that the actual distance in the z-dimension remains equal to the focal point distance to within the focal point tolerance. In some cases, the resolution of the camera assembly 18 may be less than approximately 1 micron, and the focal point tolerance of camera assembly 18 may be less than approximately 2 microns, but the described system may still achieve real-time adjustment sufficient to ensure in-focus imaging.

In order to properly measure z-axis flutter in real-time, optical sensor 26 may illuminate web material 12 with sensor light, detect a reflection of the sensor light, and determine the actual distance in the z-dimension (i.e., along the z-axis) based on lateral positioning of the reflection of the sensor light. Optical sensor 26 may be positioned in a non-orthogonal location relative to the z-dimension such that the sensor light is directed at web material 12 so as to define an acute angle relative to the z-dimension. Additional details of optical sensor 26 are outlined below.

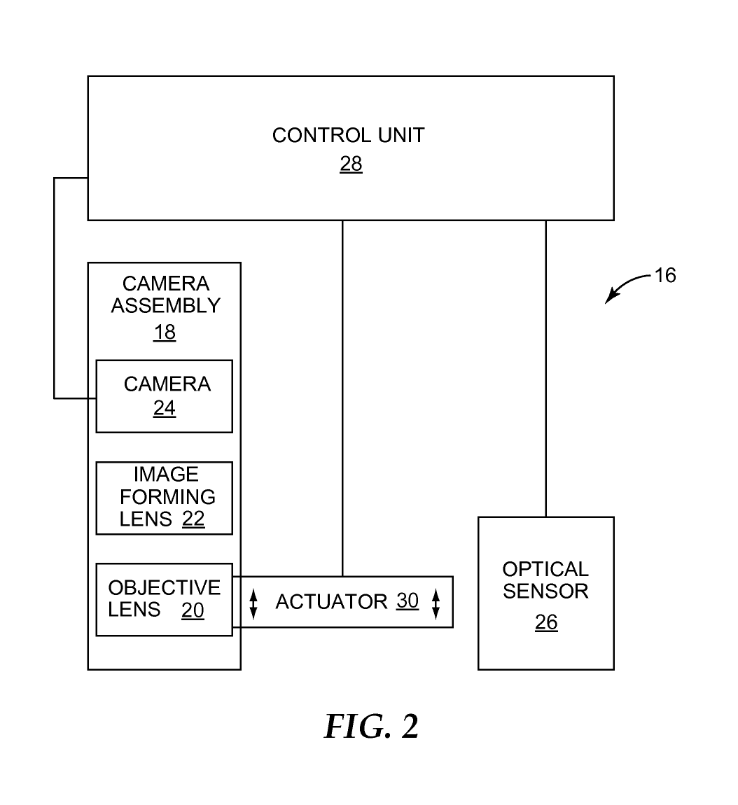

FIG. 2 is a block diagram illustrating one example of inspection device 16 consistent with this disclosure. As shown, inspection device 16 includes a camera assembly 18 comprising an objective lens 20 that captures and collimates light associated with an object being inspected, an image forming lens 22 that forms an image of the object based on the collimated light, and a camera 24 that renders the image for inspection of the object. As explained above, camera assembly 18 may define a focal point distance from objective lens 20 that defines a focal point of camera assembly 18.

Optical sensor 26 is positioned to detect an actual distance between objective lens 20 and the object (which may be a discrete object on a conveyor or a web material as outlined above). An actuator 30 controls positioning of objective lens 20 to control the actual distance between objective lens 20 and the object. Control unit 28 receives signals from optical sensor 26 indicative of the actual distance, and generates control signals for actuator 30 to adjust the actual distance such that the actual distance remains substantially equal to the focal point distance. Furthermore, if control unit 28 is a computer, control unit 28 may also execute one or more image analysis protocols or techniques in order to analyze images rendered by camera assembly 18 for potential defects in the object or objects being imaged.

Control unit 28 may comprise an analog controller for an actuator, or in other examples may comprise any of a wide range of computers or processors. If control unit 28 is implemented as a computer, it may also include memory, input and output devices and any other computer components. In some examples, control unit 28 may include a processor, such as a general purpose microprocessor, an application specific integrated circuit (ASIC), a field programmable logic array (FPGA), or other equivalent integrated or discrete logic circuitry. Software may be stored in memory (or another computer-readable medium) and may be executed in the processor to perform the auto focus techniques of this disclosure, as well as any image analysis for identifying object defects.

In order to ensure that actuator 30 can provide timely real-time adjustments to the position of objective lens 20 to ensure that camera assembly 18 remains in focus, it may be desirable to ensure that optical sensor 26 operates at a higher frequency than an image capture rate of camera 24. That is to say, the rate at which optical sensor 26 measures the actual distance between objective lens 20 and the object being imaged may be greater than the image capture rate of camera 24. Furthermore, a response time between any measurements by optical sensor 26 and the corresponding adjustments to the position of objective lens 20 via actuator 30 may be less than time intervals between two successive images captured by camera 24. In this way, real time responsiveness can be ensured so as to also ensure that camera assembly 18 stays in focus on the object being imaged, which may comprise a web material as outlined herein or possibly discrete objects passing by camera assembly 18 on a conveyor.

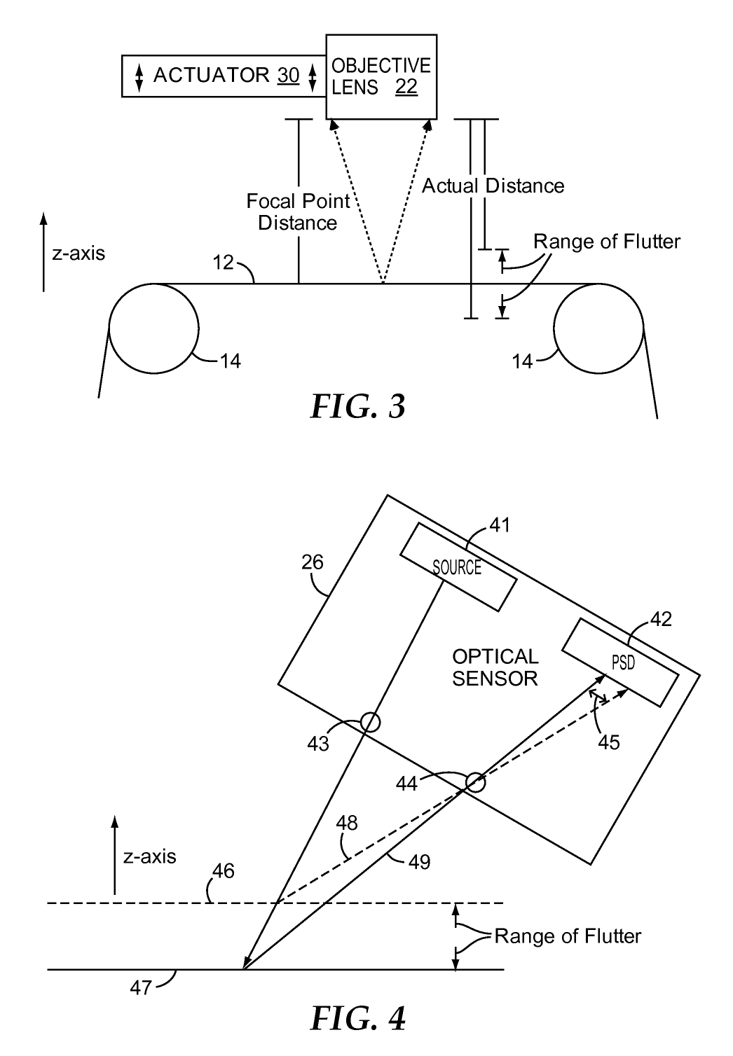

FIG. 3 is a conceptual diagram illustrating one example in which objective lens 20 is positioned relative to a web material 12. As shown in FIG. 3, web material 12 may flutter as it passes over rollers 14 or other mechanical components of the system. In practice, web material 12 moves past objective lens 20 of the inspection device (not illustrated in FIG. 3), and may flutter over a flutter distance, which may be between 25 microns and 1000 microns. In other words, the “range of flutter” shown in FIG. 3 may be between 25 microns and 1000 microns. In systems that use a conveyor rather than a web material and inspect discrete objects on the conveyor, the flutter distance may likewise be in the range of 25 microns and 1000 microns. Given this range of flutter, the actual distance between objective lens 20 and web material 12 (illustrated in FIG. 3) may vary over a range of distance. However, by adjusting the positioning of objective lens 20 via actuator 30, the inspection device can be more precisely positioned relative web material 12. In particular, according to this disclosure, objective lens 20 can remain substantially in focus on the web material due to actuator 30 controlling positioning of objective lens 20 so as to compensate for the flutter distance over the range of flutter. As mentioned, high resolution imaging can benefit from such techniques because the focal distance (and the focal point tolerance) may be very sensitive and not within the range of flutter. As an example, camera assemblies that define a resolution less than approximately 2 microns may define a focal point distance from objective lens 20 that has a focal point tolerance less than approximately 10 microns. In this case, actuator 30 may adjust the actual distance such that the actual distance remains equal to the focal point distance to within the focal point tolerance. For cameras that have a resolution less than approximately 1 micron, the focal point tolerance may be less than approximately 2 microns, an even in these cases, the techniques of this disclosure can accommodate adjustments of objective lens 20 in real time.

In general, web flutter on the order of 200 microns is much larger than the depth of field of a 2 micron resolution imaging lens, which may define a depth of field (i.e., a focal length tollernace) on the order of 10 microns. In such cases, the automatic focusing techniques of this disclosure may be very useful. Furthermore, in some case, the techniques of this disclosure may also combine a relatively low-frequency response or “coarse” adjustment of web plane with higher frequency response of camera assembly as described herein.

In one example, actuator 30 may comprise a “PZT lens driver” available from Nanomotion Incorporated. A Labview motion control card available from National Instruments Corporation may be used in control unit 28 (see FIG. 1) in order to process the information from optical sensor 26 and send control signals actuator 30 in order to move objective lens 20 for autofocus. The optical system of camera assembly 18 may use an infinity conjugated design with an objective lens and a tube lens, where only the objective lens moves via actuator 30 for autofocus and the tube lens remains in a fixed location. In one example, the optical resolution may be approximately 2 microns and a depth of field may be approximately 10 microns.

FIG. 4 is a conceptual diagram illustrating one example of an optical sensor 26 that may be configured to detect an actual distance to an object (such as a web material) in real-time. Optical sensor 26 may also be referred to as a triangulation sensor. In the example of FIG. 4, optical sensor 26 includes a source 41 that illuminates the object with sensor light, and a position sensitive detector (PSD) that detects a reflection of the sensor light, which scatters off of object 12 (not specifically shown in FIG. 4). PSD 42 determines the actual distance based on lateral positioning of the reflection of the sensor light. The scattered light may scatter randomly, but a significant portion of the scattered light may return back to PSD 42 along a path that depends upon the position of the object.

To illustrate operation of optical sensor 26, when the object is positioned at location 46, source 41 illuminates light through a point 43, which reflects off the object at location 46 and travels back to PSD 42 through point 44 along the dotted line 48. On the other hand, when the object is positioned at location 47, source 41 similarly illuminates light through a point 43, which reflects off the object at location 47, but travels back to PSD 42 through point 44 along the solid line 49. The lateral motion 45 of the reflected light at PSD 42 depends on geometry and optical components in the sensor, but it can be calibration such that the output corresponds exactly to the flutter experienced by the object.

As shown in FIG. 4 (and also shown in FIG. 1), optical sensor 26 may be positioned in a non-orthogonal location relative to the object such that the sensor light is directed at the object so as to define an acute angle relative to a major surface of the object. This may be desirable so as to ensure that optical sensor 26 detects actual flutter at a precise point that is being imaged by camera assembly 18 (see FIG. 1), while also ensuring that optical sensor 26 is not blocking objective lens 20. Flutter can be very position sensitive, and therefore, this arrangement, with optical sensor 26 being positioned in a non-orthogonal location relative to the object such that the sensor light is directed at the object so as to define an acute angle relative to a major surface of the object may be very desirable.

Simple trigonometry may be used to calibrate optical sensor 26 given the non-orthogonal positioning. In particular, given an optical sensor designed to detect motion in an orthogonal direction, trigonometry may be used to calculate the actual motion of the object if optical sensor 26 is positioned in the non-orthogonal manner proposed in this disclosure. Still an easier way of accurately calibrating optical sensor 26 may use experimental and empirical data. In this case, optical sensor 26 may be calibrated via direct measurements of the actual distance over the range of flutter. Calibrating may be performed at the extremes (e.g., associated with locations 46 and 47) as well as one or more intermediate positions between locations 46 and 47.

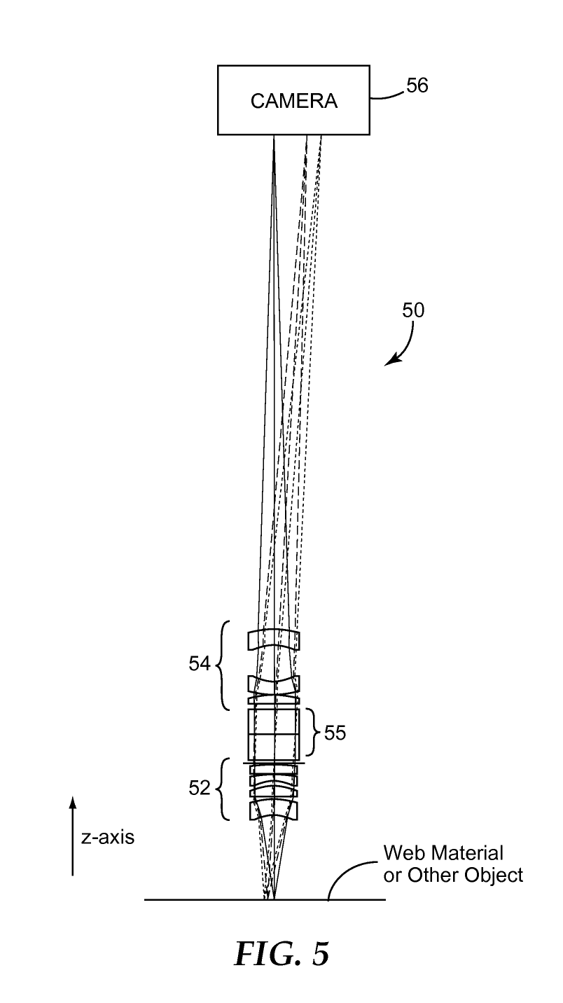

In one example, optical sensor 26 may comprise a Keyence LKH-087 sensor with a long working distance of approximately 80 millimeters, which may enable a relatively small oblique incidence angle (e.g., less than 20 degree). In other words, the acute angle defined by light from optical sensor and the surface of the web material may be approximately 70 degrees. The off center positioning of optical sensor can ensure that optical sensor does not block or impede the imaging performed by camera assembly 18 (not shown in FIG. 5).

FIG. 5 is a cross-sectional conceptual diagram illustrating an exemplary camera assembly 50 consistent with this disclosure. Camera assembly 50 may correspond to camera assembly 18, although unlike camera assembly 18, a filter 23 is not illustrated as being part of camera assembly 50. Camera assembly 50 includes an objective lens 52 that includes a first plurality of lenses, and an image forming lens 54 that includes a second plurality of lenses. Image forming lens 54 may comprise a so-called “tube lens.” Region 55 corresponds to the region between objective lens 52 and image forming lens 54 where light is collimated. Camera 56 includes photodetector elements that can detect and render the images output form imaging forming lens 54. In the example of FIG. 5, the numerical aperture (NA) of camera assembly 50 may be 0.16 and field of view may be approximately 12 millimeters with an optical resolution of approximately 2 microns. Images may be captured at a capture rate, which may be tunable for different applications. As an example, the capture rate of camera 56 may be approximately 30 frames per second if an area-mode camera is used. As another example, if a line scan camera is used, the line scan camera may process lines at a speed of approximately 100 kHz. In any case, this disclosure is not necessarily limited to cameras of any specific speed, resolution or capture rate.

In most web inspection applications, web speed may be on the order of meters per minute. At such web speed, web flutter amplitude is usually on the order of 200 micron and flutter frequency is usually tens of hertz. In order for the described techniques of this disclosure to track the web flutter movement, actuator 30 may be able to drive its load (e.g., objective lens 52) at such amplitude and such frequency, which can place practical limits on the weight of objective lens 52. For a high resolution imaging lens with a large field of view, large lens diameter and a number of lens elements may be needed to correct aberrations across field, which can make the lens heavy (on the order of Kilograms). Most piezoelectric actuators, however, can only move one kilogram loads at a few Hertz. In order to overcome this speed limit, the camera assembly 50 illustrated in FIG. 5 uses an infinite conjugate optical system approach. The lens system may include two major lens groups, an objective lens 52 (comprising a first group of lenses) and an image forming lens 54 (in the form of a second group of lens that form a tube lens group). Light rays are collimated at the region 55 between the objective lens and image forming lens. Only objective lens 52 is moved by a piezoelectric actuator (not shown in FIG. 5). Light is collimated in region 55, which can help to ensure that movement of objective lens 52 does not degrade image quality. This approach may reduce the load associated with the piezoelectric actuator, and may therefore increase the autofocus speed. Image forming lens 54 remains in a fixed location when the actuator moves objective lens 52.

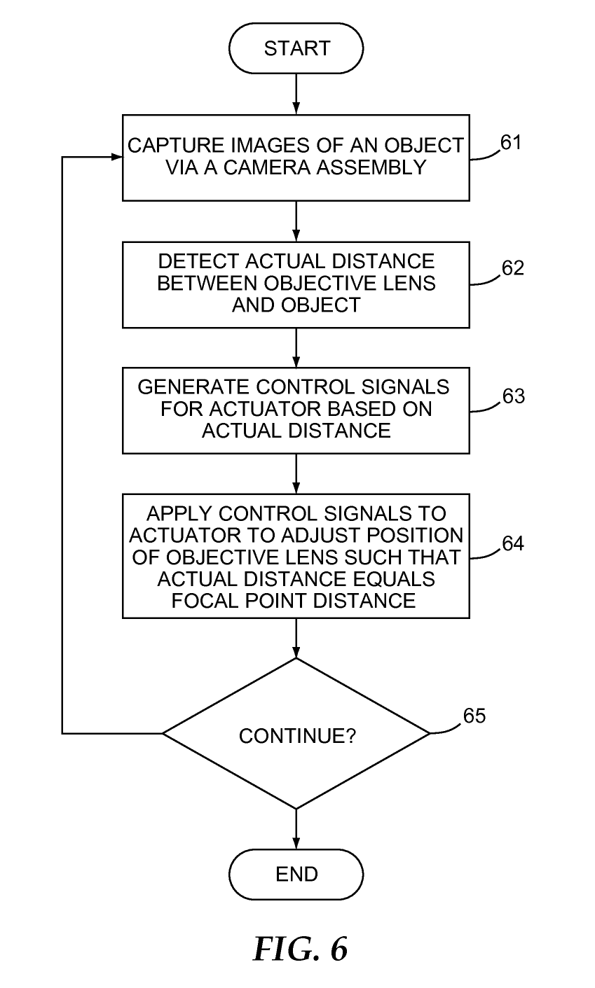

FIG. 6 is a flow diagram illustrating a technique consistent with this disclosure. As shown in FIG. 6, camera assembly 18 captures one or more images of an object (61). As described herein, camera assembly 18 may be positioned relative to the object, and camera assembly 18 may comprise an objective lens 20 that captures and collimates light associated with the object, an image forming lens 22 that forms an image of the object based on the collimated light, and a camera 24 that renders the one or more images for inspection of the object. Camera assembly 18 defines a focal point distance from objective lens 20 that defines a focal point of camera assembly 18.

According to the technique of FIG. 6, optical sensor 26 detects an actual distance between objective lens 20 and the object (62). Control unit 28 then generates control signals for an actuator 30 based on the actual distance (63). In this way, the control signals from control unit 28 can control positioning of objective lens 20 via actuator 30. The control unit 28 receives signals from optical sensor 26 indicative of the actual distance, and generates the control signals based on the received signals from the optical sensor. The control signals are then applied to actuator 30 to adjust the position of objective lens 20 such that the actual distance remains substantially equals the focal point distance (64). Image forming lens 22 and camera 24 remain in fixed locations when actuator 30 moves or adjusts objective lens 20. The process may continue (65) as a close-loop system to provide real-time auto focus of camera assembly 18 even at very high resolutions and tight focal length tolerances.

As outlined above, the techniques of this disclosure are useful for inspection of web materials that travel along a web, but may also be used for inspection of individual and discrete objects that travel on a conveyor. The structure and techniques described in this disclosure can facilitate accurate inspection and auto-focus of high-resolution inspection optics, focusing to within tolerances less than 10 microns. The described auto-focus inspection optics may compensate for so-called web flutter in the z-axis, which refers to an axis that is orthogonal to the surface of a two-dimensional web or conveyor. By achieving auto-focus at these tolerances, web inspection can be significantly improved, thereby improving the manufacturing process associated with web materials that have feature sizes less than 2 microns, or even less than one micron.

In order to inspect very large webs, it may also be desirable to implement a plurality of the inspection devices described herein in an inspection system. In such situations, the plurality of the inspection devices may be positioned in staggered locations across the web so as to image a small portion of the width of the web. Collectively, a large plurality of inspection devices could be implemented to image and inspect a web of any size and any width. The width of the web and the field of view of each of the inspection devices would dictate the number of inspection devices needed for any given inspection system.

While exemplary embodiments have been described with an emphasis on direct illumination of the surface of the web material 12 to be inspected, in some exemplary embodiments, it may be desirable to employ back-lighting (e.g. lighting from behind the web), especially when an objective is to catch defects such as shorts or breaks in the pattern. In cases where high resolution web inspection is needed, the back-lighting scheme should desirably illuminate every point inside the inspection field of view with same intensity.

One exemplary back-lighting scheme was successfully used in connection with the present disclosure, the scheme having two main design considerations. The first consideration was to focus the back-lighting light source on the entrance pupil of the objective lens to ensure that light rays emanating from the back-lighting source can pass through the inspection optical system and reach the camera. The second consideration was to let every point of the light source illuminate the full sample within the field of view of the objective lens. To achieve the first design consideration, a pair of lenses was used to relay the light source onto the entrance pupil of the inspection lens. To achieve the second design consideration, the sample was positioned at the aperture of the optics train of the illumination system.

More specifically, a light source commercially available as IT-3900 from Illumination Technology (Elbridge, N.Y.) was found to be suitable. Relay lenses commercially available as LA1422-A and LA1608-A from Thorlabs, Inc. (Newton, N.J.) were also found to be suitable for providing a backlighting scheme suitable for use with the present disclosure.

Various embodiments of the invention have been described. These and other embodiments are within the scope of the following claims.

1. An inspection device comprising:
a camera assembly including an objective lens that captures and collimates light associated with an object being inspected, an image forming lens that forms an image of the object based on the collimated light, and a camera that renders the image for inspection of the object, wherein the camera assembly defines a focal point distance from the objective lens that defines a focal point of the camera assembly;
an optical sensor positioned to detect an actual distance between the objective lens and the object;
an actuator that controls positioning of the objective lens to control the actual distance between the objective lens and the object, wherein the image forming lens remains in a fixed location when the actuator moves the objective lens; and
a control unit that receives signals from the optical sensor indicative of the actual distance and generates control signals for the actuator to adjust the actual distance such that the actual distance remains substantially equal to the focal point distance.

2. The inspection device of claim 1, wherein:
the object comprises a web material or an article on a conveyor that moves past the inspection device and flutters a flutter distance between 25 microns and 1000 microns, and
the inspection device is positioned relative to the web material or the article and remains substantially in focus on the web material or the article due to the actuator controlling positioning of the objective lens to compensate for the flutter distance.

3. (canceled)

4. The inspection device of claim 1, wherein the objective lens comprises a first plurality of lens that collectively define the objective lens, and wherein the image forming lens comprises a second plurality of lenses that collectively define a tube lens.

5. The inspection device of claim 1, wherein the camera assembly defines a resolution less than approximately 2 microns and the focal point distance defines a focal point tolerance less than approximately 10 microns, wherein the actuator adjusts the actual distance such that the actual distance remains equal to the focal point distance to within the focal point tolerance.

6. The inspection device of claim 5, wherein the resolution of the camera assembly is less than approximately 1 micron and the focal point tolerance of the camera assembly is less than approximately 2 microns.

7. The inspection device of claim 1, wherein the optical sensor illuminates the object with sensor light, detects a reflection of the sensor light, and determines the actual distance based on lateral positioning of the reflection of the sensor light.

8. The inspection device of claim 7, wherein the optical sensor is positioned in a non-orthogonal location relative to the object such that the sensor light is directed at the object so as to define an acute angle relative to a major surface of the object.

9. The inspection device of claim 1, wherein the actuator comprises a piezoelectric actuator.

10. The inspection device of claim 1, wherein a weight of the objective lens is less than one-tenth of a weight of the camera assembly.

11. (canceled)

12. A web system comprising:
a web material defining a down-web dimension and a cross-web dimension, wherein a z-dimension is orthogonal to the down-web dimension and the cross-web dimension;
one or more web-guiding elements that feed the web material through the web system; and
inspection device including:
a camera assembly comprising an objective lens that captures and collimates light associated with the web material, an image forming lens that forms an image of the web material based on the collimated light, and a camera that renders the image for inspection of the web material, wherein the camera assembly defines a focal point distance from the objective lens that defines a focal point of the camera assembly;
an optical sensor positioned to detect an actual distance in the z-dimension between the objective lens and the web material;
an actuator that controls positioning of the objective lens relative to the web material to control the actual distance between the objective lens and the web material in the z-dimension, wherein the image forming lens remains in a fixed location when the actuator moves the objective lens; and
a control unit that receives signals from the optical sensor indicative of the actual distance in the z-dimension, and generates control signals for the actuator to adjust the actual distance in the z-dimension such that the actual distance in the z-dimension remains substantially equal to the focal point distance.

13. The web system of claim 12, wherein:
the web material moves past the inspection device and flutters a flutter distance between 25 microns and 1000 microns, and
the inspection device is positioned relative to the web material and remains substantially in focus on the web material due to the actuator controlling positioning of the objective lens to compensate for the flutter distance.

14. The web system of claim 12, wherein the objective lens comprises a first plurality of lens that collectively define the objective lens, and wherein the image forming lens comprises a second plurality of lenses that collectively define a tube lens.

15. The web system of claim 12, wherein the camera assembly defines a resolution less than approximately 2 microns and the focal point distance defines a focal point tolerance less than approximately 10 microns, wherein the actuator adjusts the actual distance in the z-dimension such that the actual distance in the z-dimension remains equal to the focal point distance to within the focal point tolerance.

16. The web system of claim 15, wherein the resolution of the camera assembly is less than approximately 1 micron and the focal point tolerance of the camera assembly is less than approximately 2 microns.

17. The web system of claim 12, wherein the optical sensor illuminates the web material with sensor light, detects a reflection of the sensor light, and determines the actual distance in the z-dimension based on lateral positioning of the reflection of the sensor light.

18. The web system of claim 17, wherein the optical sensor is positioned in a non-orthogonal location relative to the z-dimension such that the sensor light is directed at the web material so as to define an acute angle relative to the z-dimension.

19. The web system of claim 12, wherein the actuator comprises a piezoelectric actuator.

20-21. (canceled)

22. A method comprising:
capturing one or more images of an object via a camera assembly positioned relative to the object, wherein the camera assembly comprises an objective lens that captures and collimates light associated with the object, an image forming lens that forms an image of the object based on the collimated light, and a camera that renders the one or more images for inspection of the object, wherein the camera assembly defines a focal point distance from the objective lens that defines a focal point of the camera assembly;
detecting, via an optical sensor, an actual distance between the objective lens and the object;
generating, via a control unit, control signals for an actuator that controls positioning of the objective lens, wherein the control unit receives signals from the optical sensor indicative of the actual distance, and generates the control signals based on the received signals from the optical sensor; and
applying the control signals to the actuator to adjust positioning of the objective lens relative to the object to control the actual distance between the objective lens and the object such that the actual distance remains substantially equal to the focal point distance, wherein the image forming lens remains in a fixed location when the actuator moves the objective lens.

23. The method of claim 22, wherein:
the object comprises a web material or an article on a conveyor that moves past the inspection device and flutters a flutter distance between 25 microns and 1000 microns, and the inspection device is positioned relative to the web material or the article and remains substantially in focus on the web material or the article due to the actuator controlling positioning of the objective lens to compensate for the flutter distance.

24-27. (canceled)

28. The method of claim 22, further comprising:
illuminating the object with sensor light via the optical sensor;
detecting a reflection of the sensor light via the optical sensor; and
determining the actual distance based on lateral positioning of the reflection of the sensor light, optionally wherein the optical sensor is positioned in a non-orthogonal location relative to the object such that the sensor light is directed at the object so as to define an acute angle relative to a major surface of the object.

29-32. (canceled)
